(19) United States
(12) Patent Application Publication
(10) Pub. No.: US 2026/0311034 A1
(43) Pub. Date: Oct. 8, 2026

(54) Multi-Label Pairwise Ranking

(71) Applicant: Google LLC, Mountain View, CA (US)

(72) Inventor: Gil Shamir, Sewickley, PA (US)

(21) Appl. No.: 19/100,852

(22) PCT Filed: Aug. 1, 2022
(86) PCT No.: PCT/US2022/039070

§ 371 Date: Feb. 3, 2025

(51) Int. Cl. G06N 20/00; G06F 16/9535

(52) U.S. Cl. CPC G06N 20/00; G06F 16/9535

(57) ABSTRACT

Provided are pairwise ranking losses for multi-label ranking problems. One example setting for the proposed approaches is when a machine learning ranking model generates a label output for a given input, where the label output is generated relative to a plurality of potential labels that correspond to relevance scores, and where the relevance scores can also define an ordering among items. The loss function(s) applied to the machine learning model capture the labels, the ranking order, and ranking score differences, integrating these into ranking optimization. Example techniques provided herein take a view of pairwise ranking in which the loss is applied only to a subset of events which is defined by the relation between labels in a pair. Each such event can dictate two symmetric events conditioned on it with opposite rankings.

### FIELD

The present disclosure relates generally to machine learning. More particularly, the present disclosure relates to pairwise ranking losses for multi-label ranking problems.

### BACKGROUND

Ranking is an important aspect of various systems or applications such as recommendation systems, information retrieval systems (e.g., search engines), and/or other systems. Ranking can refer to the concept of defining a relative ordering between potential items as responses to a particular query. A query can be implicit (e.g., defined based on context) or explicit (e.g., defined based on specific natural language and/or image input (e.g., input by a user)). A query can be user-agnostic or user-specific. Thus, items that are candidates for providing as a response to the query can be ranked, where, for example, the ranking orders the items from most relevant to less relevant.

Ranking is related to but distinct from determining a relevance score for an item relative to a query. For example, while ranking defines a relative ordering between items, a relevance score for a particular item can indicate how relevant the item is for a particular query, irrespective of other potential candidate responses to the query. One example form of a relevance score is an engagement score. In some instances, an engagement score can indicate a probability that a user will “engage” (e.g., select for further evaluation, information gathering, “click through”, etc.) a particular item if it is presented as a response to a query. In some instances, relevance scores (e.g., an engagement score) can be predicted or otherwise represented using one or more labels (e.g., a single label indicating a likelihood of engagement) or multiple labels (e.g., multiple different labels corresponding to different ranges of scores or multiple different labels corresponding to fractional labels of a binary outcome such as “engagement”).

In large scale machine learning systems that train over a large amount of data, optimizing for individual relevance scores (e.g., engagement rates) does not always lead to the same results as optimizing for ranking. For some systems, only ranking is important, and these systems would ideally optimize only for ranking. However, due to sparsity in such systems, where items rarely co-occur in the same recommendation set, it may be infeasible to directly optimize for ranking only. Other systems, like click-through-rate (CTR) predictions, may need good predictions of both individual relevance scores (or of individual labels) and of ranking. Thus, techniques that enable systems to train on both ranking and individual scoring objectives with improved balance are desired in the art.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform training for multi-label pairwise ranking. The method includes processing, by a computing system comprising one or more computing devices, a first input with a machine-learned ranking model to generate a first intermediate representation for the first input. The method includes processing, by a computing system comprising one or more computing devices, a second input with the machine-learned ranking model to generate a second intermediate representation for the second input. The method includes generating, by the computing system, a first label output for the first input based on the first intermediate representation, wherein the first label output is generated relative to a plurality of potential labels. The method includes generating, by the computing system, a second label output for the second input based on the second intermediate representation, wherein the second label output is generated relative to the plurality of potential labels. The method includes generating, by the computing system, a ranking output for the first input and the second input based on the first intermediate representation and the second intermediate representation, wherein the ranking output indicates a relative ranking between the first input and the second input. The method includes evaluating, by the computing system, one or more ranking loss functions based on the ranking output, wherein the one or more ranking loss functions comprise a conditional loss that is conditioned on a conditioning event partitioned into two complement sets of events. The method includes modifying, by the computing system, the machine-learned ranking model based on the one or more ranking loss functions.

Another example aspect of the present disclosure is directed to a computer system. The computer system includes one or more processors and one or more non-transitory computer-readable media. The one or more non-transitory computer-readable media collectively store a machine-learned ranking model configured to generate ranking outputs for pairs of inputs that are responsive to a query and configured to generate a respective label output for each input relative to a plurality of potential labels. The machine-learned ranking model has been trained using one or more ranking loss functions, wherein the one or more ranking loss functions comprise a conditional loss that is conditioned on a conditioning event partitioned into two complement sets of events. The one or more non-transitory computer-readable media collectively store instructions that, when executed by the one or more processors, cause the computer system to run the machine-learned ranking model configured to generate one or both of: (a) ranking outputs for the pairs of inputs that are responsive to a query; or (b) the respective label output for each input relative to the plurality of potential labels.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 shows a graphical illustration of a conditional interpretation of joint direct pointwise engagement rate label prediction training with pairwise ranking training.

FIGS. 2A-B show graphical illustrations of pairwise implementations of joint multi-label engagement rate label prediction training with conditional ranking training.

FIG. 3A depicts a block diagram of an example computing system.

FIG. 3B depicts a block diagram of an example computing device.

FIG. 3C depicts a block diagram of an example computing device.

Reference numerals that are repeated across plural figures are intended to identify the same features in various implementations.

### DETAILED DESCRIPTION

### Overview

Generally, the present disclosure is directed to pairwise ranking losses for multi-label ranking problems. One example setting for the proposed approaches is when a machine learning ranking model generates a label output for a given input, where the label output is generated relative to a plurality of potential labels that correspond to relevance scores, and where the relevance scores also define an ordering among items. In particular, unlike most ranking work, in this setting not only the ordering by relevance scores matters, but also the actual labels themselves. As such, the loss function(s) applied to the machine learning model should capture the labels, the ranking order, and ranking score differences, integrating these into ranking optimization. The present disclosure considers a number of general cases. In one example case, predictions provide probabilities of the different label (score) classes based on their ranking, and ranking can provide conditional ranking probabilities between pairs of items conditioned on the event that the items have unequal ranking. Such a loss allows also for adjusting predictions by the label differences between items in the same set. A second case is a binary case where multi-labels can be interpreted as fractional labels of a binary outcome. Pairwise ranking losses based on the conditional probability that one of the items has a better label than the other can be adapted to this case. As provided by the present disclosure, these losses can be interpreted as conditional probabilities. Given this conditional probability interpretation of these losses, they can be easily integrated in optimization that combines ranking with individual item pointwise multi-class label optimization. For all cases, example techniques provided herein take a view of pairwise ranking in which the loss is applied only to a subset of events which is defined by the relation between labels in a pair. Each such event can dictate two symmetric events conditioned on it with opposite rankings.

More particularly, an ideal optimization approach for various ranking systems where both individual relevance scores and ranking matter may combine ranking and individual relevance scoring into a multi-objective training approach and loss function. When combining ranking and relevance scoring, it may be efficient to use a shared intermediate representation from a shared model to provide the signal for both ranking and pointwise individual relevance scoring (e.g., to separately generate the ranking and relevance score predictions from the intermediate representation(s)). One example intermediate representation that can be used is a set of logit scores. Thus, while portions of the present disclosure will focus on use of logit scores, it should be understood that these portions can be equally applied to other intermediate representations (e.g., “embeddings”). Using logit intermediate scores that are shared between an individual relevance and a ranking task with correct configuration can give ranking losses interpretation of losses optimizing conditional probabilities

In the binary label case, ranking and relevance scoring can be combined using a pairwise approach, applied only on pairs for which opposite labels have been observed, ignoring pairs with equal labels. This approach can be seen as applying a conditional ranking loss, where a loss is applied on a pair of items conditioned on the event where the items have opposite labels. Optimization seeks the best conditional probability of one item having a better label than the other conditioned on the items having opposite labels. This conditional probability can be attained by using the logistic (Sigmoid) function on logit score differences between the items. The same approach can be generalized to listwise losses applying the Softmax function on a list of items conditioned on the event that exactly one item has a positive outcome and all others negative ones. Various other listwise losses, optimizing ranking scores, have been proposed, but they are not always compliant with probability optimization that can be attained with logistic regression, and they may not be generalizable to multiple labels, where it is also important to predict correct labels.

Combining ranking loss with individual item label loss is a balancing act between two objectives that may agree only if models are fully correctly specified and labels are independently distributed, but do not agree in practice. With logistic regression, while an individual engagement rate focuses on the empirical distribution of the labels, the ranking loss focuses on the empirical distribution of the label (logit) differences. If the pairwise approach, which equally divides the pairwise label when label ties occur, is used, the ranking loss effectively regularizes ranking predictions towards 0 in logit space. On the other hand, the conditional approach, which applies the ranking loss only when labels are unequal, emphasizes the difference between items, pushing ranking prediction away from 0 logit. When ranking loss is combined with individual label loss, both ranking methods described can be viewed as regularizers on top of the direct label loss, where one regularizes differences towards 0 in logits, and the other away from 0. In either case, they are biased and may not push to the same optima as the direct label loss.

In various applications, engagement outcomes may be recorded as multi-label ones, where the labels also describe ranking order or relevance scores, e.g., a larger label means a better engagement or better relevance. Examples include ratings of an item, as opposed to just engagement with the item, as well as quantization of a continuous engagement measure into multiple buckets, where, e.g., a larger score means a better engagement. Scores that count the number of engagements with a recommended item in recommendation systems can also be included in this setup. One objective of the present disclosure is to provide a ranking loss that is well-aligned with scores learned for individual engagement rates, can be interpreted as a probability measure, but that is able to capture label order relations.

In particular, some example implementations of the present disclosure correspond to a logistic regression approach with either Softmax labels for the multi-label problem, or Sigmoid binary labels for the case where engagement responses may be interpreted as fractional labels. The interpretation described above of a pairwise ranking loss as a conditional loss, conditioned on some (conditioning) event, is applied to the multi-label setting. Each pair of items with a pair of unequal labels can belong to some conditioning event. Within this conditioning event, a partition can be chosen that creates two complement events conditioned on this event, which provide opposite ranking scores between the two items in the pair. Logit scores (e.g., binary logit scores) can then be defined that, conditioned on the original conditioning event, discriminate between the two conditional events with opposite rankings. Opposite binary ranking scores on these two events lead to the definition of a conditional loss. Unlike the case of binary labels where there is only a single conditioning event, the loss in the multi-label case can be defined on a collection of initial conditioning events, which may (or may not) form a partition of all possible pairwise ranking events into disjoint sets. The pair of conditioned events partitions the conditioning event into two complementing sets. A pairwise event can invoke the conditioning event and one of the events conditioned on it. The event invoked determines the “pairwise label” which in turn determines a loss relative to learned per-label per-item model parameters. Such parameters can be multi-label softmax logit scores of the possible labels an item can have. The pairwise event may equal the conditioned event or may be a subset of it. Intersecting conditioning events are possible, as long as a pairwise event is clearly associated by definition with only one of the conditioning events. This approach also allows easy combination of ranking losses with learning of the individual label losses.

More precisely, let Cᵢⱼ be a conditioning event defined on the label pair {yᵢ,yⱼ}. Let Eᵢ and Eⱼ be a partition of Cᵢⱼ, such that Eᵢ∪Eⱼ=Cᵢⱼ and (optionally) Eᵢ∩Eⱼ=φ (the empty set). Let the pair {k,l}∈Cᵢⱼ. Then, if by definition, we choose to invoke Cᵢⱼ (and not another conditioning event) for the loss, then if {k,l}∈Eᵢ the loss is −log P(Eᵢ|C_{[ij]}), and if {k,l}∈Eⱼ, then −log P(Eⱼ|C_{[ij]}) is the loss for the pairwise event {yᵢ,yⱼ}={k,l}. Allowing Cᵢⱼ, Eᵢ, and Eⱼ to be based on multiple events gives a smoothing effect, which can allow implicit label smoothing over adjacent labels. Such smoothing can allow us to define losses that move prediction scores of several labels for items i and j which may be beneficial if there is a gap between the true labels of items i and j; yᵢ and yⱼ.

This general approach can give two important technical benefits: First, determining the conditioning and the conditioned events is a form of regularization that emphasizes the traits important for the ranking loss which is designed. Second, in some of the cases, like the binary one, this gives a direct relation between the logits learned for label loss and those for pairwise ranking. Such relations can simplify the optimization for ranking in terms of the individual items' engagement logit scores. Determining the conditioning events and their partitioning to pairwise ranking events can determine how label logit scores for a pair of items should be updated to improve ranking among items. The approach allows different methods that can focus on different aspects of ranking in such updates.

### Example Discussion of Binary Ranking Conditional Pairwise Ranking

This section first overviews a conditional interpretation of an example pairwise approach in a binary label setting: Let t∈{1, 2, . . . , T} denote the index of a set of Nₜ examples (shown for the t-th query) in the training dataset. Let

$${y}_{i}^{t}$$

denote the label of example i in query t. Let

$${y}_{ij}^{t}$$

∈{0, 1} denote the joint conditional label of example i having a positive label and example j having a negative one (label 1) or vice versa (label 0), conditioned on the event that

$${y}_{i}^{t} \neq {y}_{j}^{t} .$$

### Use

$${s}_{i}^{t}$$

to denote the logit score produced by the model for example i. Note that while a logit score is described as an example intermediate representation, other intermediate representations can be used as well. Then, the direct engagement loss is given by:

$${L}_{engagement - rate} = {\sum }_{t = 1}^{T} {\sum }_{i = 1}^{{N}_{i}} \{ {y}_{i}^{l} log [ 1 + exp ( - {s}_{i}^{t} ) ] + ( 1 - {y}_{i}^{t} ) log [ 1 + exp ( {s}_{i}^{t} ) ] \}$$

where the probability of engagement predicted for example i in the t-th query is

$${p}_{i}^{t} = σ ( {s}_{i}^{t} ) {=}^{Δ} \frac{1}{1 + exp ( - {s}_{i}^{t} )}$$

and sigma is used to denote the logistic function.

To add a ranking loss, we can now define the probability given by the logistic function of the logit score difference, which is given by

$${p}_{ij}^{t} = σ ( {s}_{i}^{t} - {s}_{j}^{t} ) {=}^{Δ} \frac{1}{1 + exp ( {s}_{j}^{t} - {s}_{i}^{t} )}$$

A ranking loss applied on this probability can then be given by

$${L}_{ranking - conditional} = {\sum }_{t = 1}^{T} {\sum }_{i = 1}^{{N}_{i}} {\sum }_{j = 1 , j \neq i , {y}_{j}^{t} \neq {y}_{i}^{t}}^{{N}_{t}} {y}_{ij}^{t} log [ 1 + exp ( {s}_{j}^{t} - {s}_{i}^{t} ) ] .$$

By the inverse function of the Sigmoid, it can be shown that b gives the conditional

$${p}_{ij}^{t}$$

probability of a positive/negative label pair conditioned on unequal labels. For brevity, we omit the query superscript t in the analysis.

$${e}^{{s}_{i}} = \frac{{p}_{i}}{1 - {p}_{i}} , {e}^{{s}_{j}} = \frac{{p}_{j}}{1 - {p}_{j}} , ⇒ {e}^{{s}_{i} - {s}_{j}} = \frac{{p}_{i} ( 1 - {p}_{j} )}{{p}_{j} ( 1 - {p}_{i} )} \qquad ( 1 )$$

It follows that

$${p}_{ij} = \frac{1}{1 + exp ( {s}_{j} + {s}_{i} )} = \frac{1}{1 + \frac{{p}_{j} ( 1 - {p}_{i} )}{{p}_{i} ( 1 - {p}_{j} )}} = \frac{{p}_{i} ( 1 - {p}_{j} )}{{p}_{i} ( 1 - {p}_{j} ) + {p}_{j} ( 1 - {p}_{i} )} = Pr ( {y}_{i} = 1 , {y}_{j} = 0 \vert {y}_{i} \neq {y}_{j} ) .$$

Note that the last equality, relating pᵢⱼ to the conditional probability, is only true under the assumption that the events represented by pᵢ and pⱼ are independent. This is clearly not the case in practice. However, we expect that the conditional ranking loss combined with the pointwise engagement loss will yield an optimum that balances between the marginal independent predictions of the direct engagement model, and the ranking predictions of the ranking model, which do model the effects of one item over the other, and are thus not independent by definition. We can think of pᵢ and pⱼ as some expectation of a product of a marginal probability (pᵢ) and conditional pⱼ (conditioned on the event represented by pᵢ).

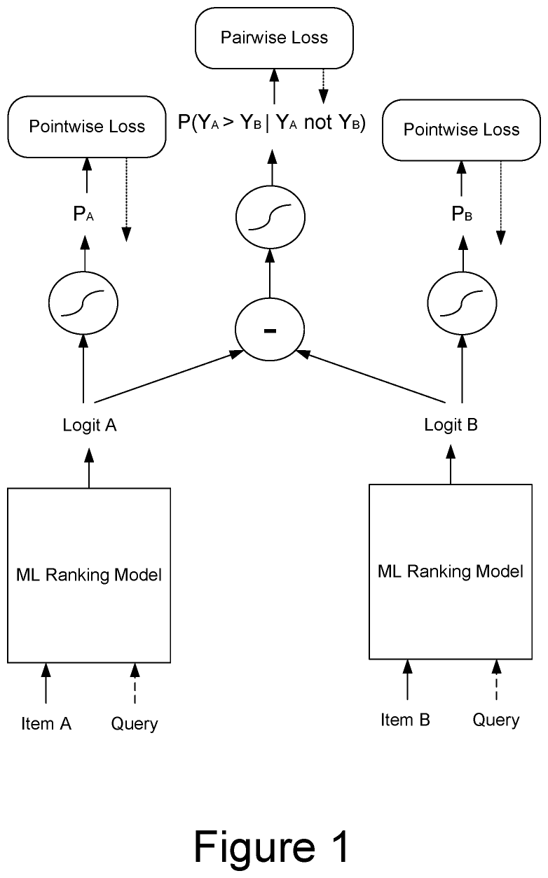

FIG. 1 shows an example of a pair of items in the same set (query) for which the model trains with both direct engagement rate and conditional pairwise ranking loss as described in the equations above. Specifically, FIG. 1 shows a graphical illustration of a conditional interpretation of joint direct pointwise engagement rate label prediction training with conditional ranking training. A machine learning ranking model generates a respective engagement probability for each of items A and B by first generating a respective logit score for each item. The respective logit score for each item is converted by the Logistic (Sigmoid) function to probability of a positive label (shown as P_{A} for item A and P_{B} for item B). A difference between the two respective logit scores can be converted to a conditional probability that the label of A is greater than that of B (i.e., that A should be ranked higher than B) conditioned on the labels being unequal.

The proof that a ranking loss as defined above models the conditional probability conditioned on unequal labels can be generalized to listwise Softmax multi-item losses to show that a similar approach, using Softmax on logits, where there is a Softmax component to the binary logit of each item, models the ranking probability as the conditional probability of an item having positive engagement conditioned on the event that exactly one item in the set has a positive engagement while all other items have negative ones.

### Example Discussion of Multi-Label Pairwise Ranking

Now consider the same pairwise setting, but in which individual outcomes have multiple labels, where the actual label values make a difference. Without loss of generality, we can consider a set of L integer labels {0, 1, 2, . . . , L−1}, where, e.g., a larger label means a better score and higher ranking (more relevance), and in the engagement case, a 0 label means no engagement at all. If item i has a larger label than item j, it is ranked higher. We may care only which item is ranked higher in a pair of two, or also how much higher the ranking of i is relative to j.

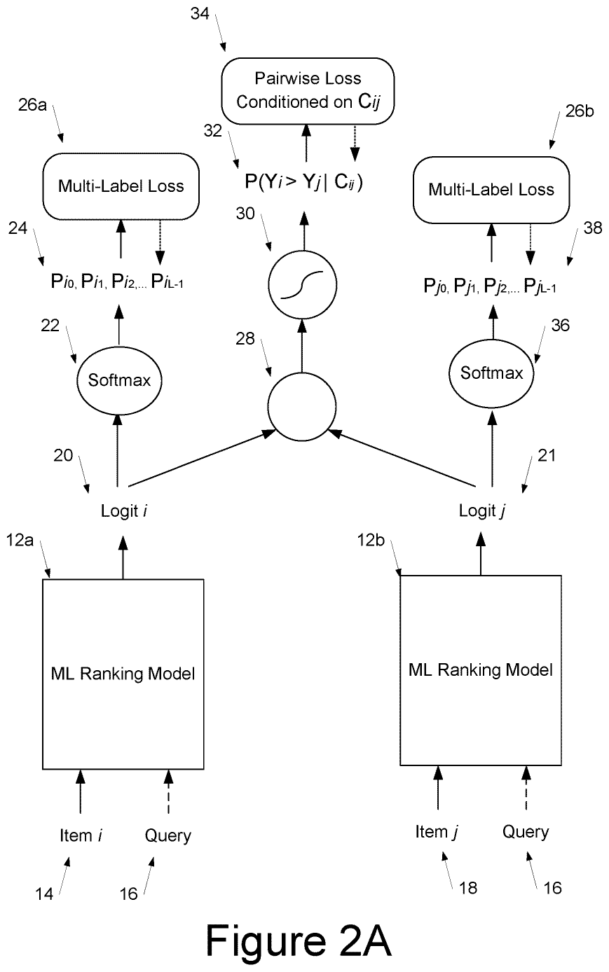

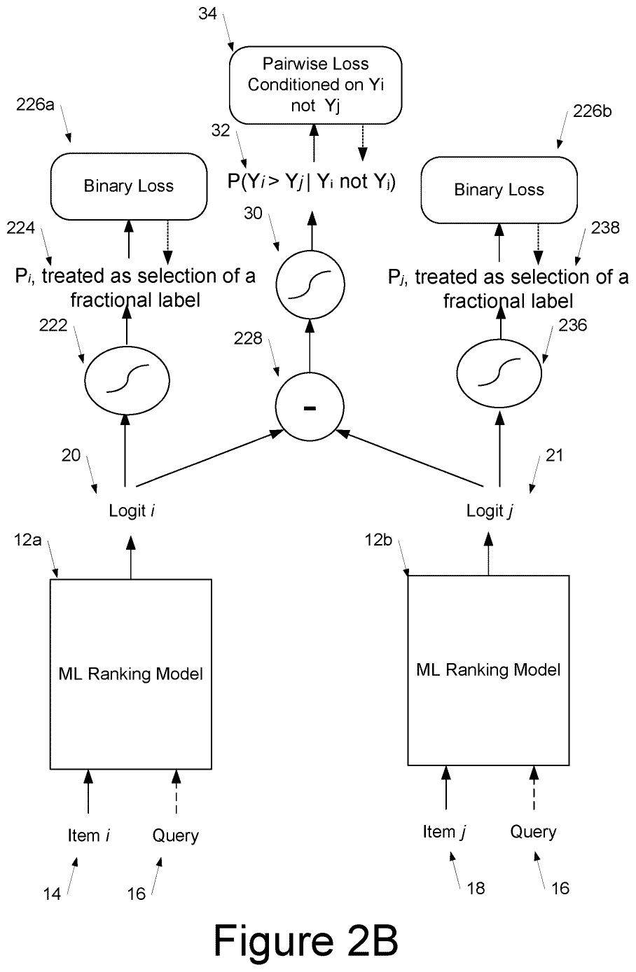

FIGS. 2A and 2B show example illustrations of this multi-label setting. Specifically, referring to both FIGS. 2A and 2B, a machine learning ranking model 12a can process a first input (e.g., item i 14 and, optionally, data descriptive of a query 16) to generate a first intermediate representation (e.g., shown as logit i 20) for the first input. The machine learning ranking model 12b can also process a second input (e.g., item j 18 and, optionally, data descriptive of the query 16) to generate a second intermediate representation for the second input (e.g., shown as logit j 21). The machine learning ranking model 12b can be the same model as model 12a (e.g., two instantiations of the same model parameters).

The items 14 and 16 can be any item such as a resource, a webpage, a file, a product, an entity, a user, and/or any candidate result (e.g., responsive to the query 16). The query can be any kind of query including a natural language query, an image query, a query that includes user data, a query that includes context data, a query that includes metadata, and/or any other form of query. Although the intermediate representations are shown as logits, other forms of intermediate representations can be used (e.g., embeddings from a hidden layer).

A computing system can generate a first label output for the first input based on the first intermediate representation. Specifically, the first label output can be a multi-label output that is generated relative to a plurality of potential labels. Similarly, the computing system can generate a second label output for the second input based on the second intermediate representation. Specifically, the second label output can be a multi-label output that is generated relative to a plurality of potential labels.

As an example, as shown in FIG. 2A, a softmax operation 22 can transform the logit i 20 into a set of probability values 24, where each probability value in the set 24 corresponds to a predicted probability of item i 14 having a respective one of the plurality of potential labels. The set of probability values 24 can be evaluated using a multi-label loss function 26a. For example, the multi-label loss function 26a can compare the set of probability values 24 to a ground truth label for the item i 14. The multi-label loss function 26a can be backpropagated (e.g., to modify parameter values of the machine learning ranking model 12a).

Likewise, referring still to FIG. 2A, a softmax operation 36 can transform the logit j 21 into a set of probability values 38, where each probability value in the set 38 corresponds to a predicted probability of item j 18 having a respective one of the plurality of potential labels. The set of probability values 38 can be evaluated using a multi-label loss function 26b. For example, the multi-label loss function 26b can compare the set of probability values 38 to a ground truth label for the item j 18. The multi-label loss function 26b can be backpropagated (e.g., to modify parameter values of the machine learning ranking model 12b).

Referring now to FIG. 2B, as another example, a logistic (Sigmoid) function 222 can be used to transform the logit i 20 into a probability value that can be treated as selection of one of the plurality of potential labels, where the potential labels correspond to fractional outcomes of a binary label (e.g., as shown at 224). The selection at 224 of one of the fractional labels can be evaluated by a binary label loss function 226a. In the binary label loss function 226a, the computing system can map the multiple-labels into points on the outcome of the binary probability. The fractional binary label loss function 226a representing the multi-label value can be backpropagated (e.g., to modify parameter values of the machine learning ranking model 12a).

Likewise, referring still to FIG. 2B, a logistic (Sigmoid) function 236 can be used to transform the logit j 21 into a probability value that can be treated as selection of one of the plurality of potential labels, where the potential labels correspond to fractional outcomes of a binary label (e.g., as shown at 238). The selection at 238 of one of the fractional labels can be evaluated by the binary loss function 226b representing multiple labels. For example, the loss function 226b can compare the selected label 238 to a ground truth label for the item j 18. The loss function 226b can be backpropagated (e.g., to modify parameter values of the machine learning ranking model 12b).

Although the use of softmax operators 22 and 36 is shown in FIG. 2A and the use of logistic functions 222 and 236 is shown in FIG. 2B, other operators and/or model layers can be used to generate the label outputs from the intermediate representations. For example, one or more fully connected layers can be included (e.g., prior to a softmax operator or logistic function).

Referring now again to FIGS. 2A and 2B collectively, according to an aspect of the present disclosure, the computing system can generate a ranking output 32 for the first input and the second input based on the first intermediate representation and the second intermediate representation. The ranking output can indicate a relative ranking between the first input and the second input. For example, the ranking output can indicate a probability that the label for item i 14 is greater than the label for item j 18 (e.g., which may indicate that item i 14 should be ranked higher than item j 18. As will be discussed further with reference to the corresponding ranking loss function 34, the ranking output 32 can be conditioned on a conditioning event.

In particular, as one example, as shown in FIG. 2A, a computing system can determine an aggregate (e.g., by applying an aggregation operation 28) of the logit i 20 and the logit j 21. The computing system can generate the ranking output 34 based on said aggregate. As one example, a logistic function 30 can be applied to the aggregate to generate the ranking output. In other examples, one or more model layers (e.g., fully connected neural network layers) and/or other operators can be positioned between the intermediate representations and the ranking output 32). In some implementations, the aggregation operation can be determined by the specific equation of the loss as described herein so as to give some logit value sᵢⱼ that maps the vectors zᵢ and zⱼ as a function of the label values yᵢ and yⱼ to a binary logit. Then, this logit is transformed at 30 into a conditional probability of some relation between the label yᵢ and yⱼ conditioned on an event that includes both values of the binary event. For example, conditioned on the conditioning event Yᵢ>Yⱼ is the positive event represented by sᵢⱼ and Yⱼ>Yᵢ is the negative one.

As another example, as shown in FIG. 2B, a computing system can determine a difference (e.g., by applying a subtraction operation 228) between the logit i 20 and the logit j 21. The computing system can generate the ranking output 34 based on said difference. As one example, a logistic function 30 can be applied to the difference to generate the ranking output. In other examples, one or more model layers (e.g., fully connected neural network layers) and/or other operators can be positioned between the intermediate representations and the ranking output 32).

The computing system can evaluate a ranking loss function

$$( {L}_{ij}^{R} )$$

34 based on the ranking output 32. In particular, according to an aspect of the present disclosure, and as will be discussed in further detail below, the ranking loss function 34 can be a conditional loss that is conditioned on a conditioning event partitioned into two complement sets of events, the two complement sets of disjoint events The computing system can modify the machine-learned ranking model (12a and 12b) based on the ranking loss function 34. For example, the ranking loss function 34 can be backpropagated to update the parameters of the models 12a and 12b. Example implementations of the ranking loss function 34 will now be discussed in further detail.

The remainder of the present disclosure considers loss contribution in a single query and drops the dependence on the query index t for brevity. More precisely, for ease of explication, we only consider a pairwise loss of items (or examples) i and j in a given query, and denote

$${L}_{ij}^{R}$$

as the contribution of the pair i, j to the overall ranking loss. As standard in multi-label problems, a Softmax score zᵢᵥ, v∈{0, 1, . . . , L−1} can be computed for each of the L labels. Such a score is agnostic to label relations, so the ordering that label k>l means a better label for k than l is not reflected in the raw Softmax scores. The probability of each label value k is given by

$${p}_{ik} {=}^{Δ} \frac{{e}^{{z}_{ik}}}{{\sum }_{ℓ = 0}^{L - 1} {e}^{{z}_{i ℓ}}} = \frac{1}{( 1 + {\sum }_{ℓ = 0 , ℓ \neq k}^{L - 1} {e}^{( {z}_{i ℓ} - {z}_{ik} )} )} {=}^{Δ} \frac{{e}^{{z}_{ik}}}{{V}_{i}}$$

where we use

$${V}_{i} {=}^{Δ} {\sum }_{ℓ = 0}^{L - 1} {e}^{{z}_{i ℓ}}$$

to denote the normalizing sum of exponents.

Example implementations extend the approach (or interpretation) described in a previous section for pairwise ranking with binary labels, in which a ranking loss is applied conditioned on some event. As described, in the binary case, it was a single event of the examples taking opposite labels. For the multi-label case, we can condition the ranking loss for multiple events, e.g., the ranking loss will be applied on a union of several conditioning events which need not be mutually exclusive, as long as the loss is well defined for a given pair of labels. For each conditioning event, a pair of events conditioned on the conditioning event can be defined by a binary logit value which will take one sign if items are ordered in one direction, and the opposite sign if the opposite direction.

Because there are multiple ways to define pairwise ranking relations between different label values, there can be multiple ways to define ranking losses. For example, if a pair of examples have non-consecutive labels k and l, k>l, a ranking loss can either push the probability of k up for the first example and that of l up in the second, it can push the probability of the larger label up, and that of the smaller label down for one item, and apply the opposite for the other item. It can also, however, influence all other label values, specifically those between the l and k. If for example, item i has label k=9, and item j has label l=1, clearly item i should be ranked higher based on this pair than item j. So, the probability that item i takes label 9 should increase and the probability that item j takes label 1 should increase. A ranking loss could also (but does not have to) decrease the probabilities that item i takes label 1 and that item j takes label 9. But what about the probabilities of both items taking labels in {2,3,4,5,6,7,8}?A loss that increases zᵢ₉ and zⱼ₁ will implicitly lower all probabilities of items i and j taking any different label values. A loss that increases zᵢ₉ and zⱼᵢ and also decreases zᵢ₁ and zⱼ₉ will implicitly affect pᵢᵥ, and pⱼᵥ for v in this set through the Softmax function, but it could either increase or decrease them depending on the actual values of all parameters. We define different approaches for multi-label ranking losses, each handling these questions differently. The most conservative approach is to apply a loss almost similar to the individual label loss, but only when labels of both items are unequal. As the importance of ranking differences is more critical, more “aggressive” ranking losses that deviate more from the individual label losses may be better suited. An approach should be chosen based on what fits the specific application. We begin with some notation.

Define the log partial Softmax sum

$${Z}_{i ; ℓ : k} {=}^{Δ} log ( {\sum }_{v = ℓ}^{k} {e}^{{Z}_{iv}} )$$

as the logarithm of the partial sum of Softmax label score exponents, computed only on the subset of labels defined by the boundaries l and k. Thus

$$Pr ( {y}_{i} ∈ \{ ℓ , ℓ + 1 , … , k \} ) = \frac{{e}^{{Z}_{i ; ℓ : k}}}{{V}_{i}}$$

gives the probability of an event consisting of all labels in the subset, i.e., this event is true if item i takes any of these labels. Specifically Z_{i;0:L-1}=log Vᵢ. Define

$${Z}_{i ; - k} {=}^{Δ} log ( {\sum }_{v = 0 , v \neq k}^{L - 1} {e}^{{Z}_{iv}} )$$

as the partial sum of softmax labels excluding the k-th element. Then

$$Pr ( {y}_{i} \neq k ) = \frac{{e}^{{Z}_{i : - k}}}{{V}_{i}}$$

gives the probability that yᵢ doesn't take label k.

### Example Extension of the Binary Conditional Loss to Multi-Labels

The simplest way to shift the loss to focus more on ranking is by applying a pairwise joint probability loss only when labels are unequal. This gives a loss

$${L}_{ij}^{ℛ} = - I ( {y}_{i} \neq {y}_{j} ) log ( {p}_{i} {p}_{j} ) = I ( {y}_{i} \neq {y}_{j} ) \{ ( log {V}_{i} + log {V}_{j} ) - ( {z}_{i ; {y}_{i}} + {z}_{j ; {y}_{j}} ) \}$$

for items i and j, where I(⋅) is the indicator function, and pᵢ, pⱼ are shorthand notation for the probabilities of items i and j, taking labels yᵢ, yⱼ, respectively. This loss is almost a superposition of the individual engagement label loss, except that it is conditioned on the event in which the labels are unequal. This conditioning shifts the loss to focus on label differences and discards events where labels are equal. This loss, however, clearly creates a bias by discarding pairs with equal labels, and not scaling the probabilities of unequal labels by using a conditioning event. It thus does not fall in the class of losses considered herein, because the events on which two opposite labels are applied are not a partitioning of a conditioning event into two opposite labels.

This can be corrected by making this loss a direct extension of the binary case described earlier. Define the logit sᵢⱼ for {yᵢ=k, yⱼ=l}, k≠l, conditioned on the event that either both yᵢ=k and yⱼ=1 or both yᵢ≠k, yⱼ≠l. The conditioning excludes the events in which yᵢ=k and yⱼ≠l, and yᵢ≠k and yⱼ=l from the loss definition. However, the conditioning event does include the complement event. This gives

$${s}_{ij} = log \frac{Pr ( {y}_{i} = k , {y}_{j} = ℓ )}{Pr ( {y}_{i} \neq k , {y}_{j} \neq ℓ )} = log [ \frac{Pr ( {y}_{i} = k )}{Pr ( {y}_{i} \neq k )} \cdot \frac{Pr ( {y}_{j} = ℓ )}{Pr ( {y}_{j} \neq ℓ )} ] = log [ \frac{{e}^{{z}_{ik}} / {V}_{i}}{{e}^{{Z}_{i ; - k}} / {V}_{i}} \cdot \frac{{e}^{{z}_{j ℓ}} / {V}_{j}}{{e}^{{Z}_{j ; - ℓ}} / {V}_{j}} ] = ( {z}_{ik} + {z}_{j ℓ} ) - ( {z}_{i ; - k} + {z}_{j ; - ℓ} )$$

and the conditional probability

$$Pr \{ {y}_{i} = k , {y}_{j} = ℓ \vert [ \{ {y}_{i} = k , {y}_{j} = ℓ \} or \{ {y}_{i} \neq k , {y}_{j} \neq ℓ \} ] \} = σ ( {s}_{ij} ) .$$

For every {yᵢ,yⱼ}, a loss

$${L}_{ij}^{ℛ} = I ( {y}_{i} \neq {y}_{j} ) log \{ 1 + exp [ - {s}_{ij} ( {y}_{i} , {y}_{j} ) ] \}$$

can be applied. This is a direct extension of the binary labels case because sᵢⱼ is derived from the product of ratios Pr(yᵢ=k)/Pr(yⱼ≠k) and Pr(yⱼ=l)/Pr(yⱼ≠l), where in the binary case, we take k=1 and l=0 to match equation (1).

### Example Naive Multi-Label Ranking Loss

This section continues with another example approach that simplifies the conditioning event to depend only on the labels k and l of the pair of items. We define the logit on the conditioning event that one of yᵢ and yⱼ takes label k and the other label l excluding k=l. Thus

$${s}_{ij} = log \frac{Pr ( {y}_{i} = k , {y}_{j} = ℓ )}{Pr ( {y}_{i} = ℓ , {y}_{j} = k )} = log [ \frac{Pr ( {y}_{i} = k )}{Pr ( {y}_{i} = k )} \cdot \frac{Pr ( {y}_{j} = ℓ )}{Pr ( {y}_{j} = ℓ )} ] = log [ \frac{{e}^{{z}_{ik}} / {V}_{i}}{{e}^{{z}_{i ℓ}} / {V}_{i}} \cdot \frac{{e}^{{z}_{j ℓ}} / {V}_{j}}{{e}^{{Z}_{jk}} / {V}_{j}} ] = ( {z}_{ik} - {z}_{i ℓ} ) - ( {z}_{jk} - {z}_{j ℓ} ) = ( {z}_{ik} + {z}_{j ℓ} ) - ( {z}_{i ℓ} + {z}_{i k} ) \qquad ( 2 )$$

This equation gives a similar notion to equation (1), where sᵢ is zᵢₖ−zᵢₗ, and sⱼ is zⱼₖ−zⱼₗ. It may, however, be more convenient to use the form of the right hand side of the equation. As described, sᵢⱼ gives log-odds of the conditional probability

$$Pr [ {y}_{i} = k , {y}_{j} = ℓ \vert ( {y}_{i} , {y}_{j} ) = π ( k , ℓ ) ] = σ ( {s}_{ij} )$$

where π(k,l) is any permutation of (k,l) (where there are only two such permutations).

The ranking loss can now be defined as

$${L}_{ij}^{ℛ} = I ( {y}_{i} > {y}_{i} ) \vert {y}_{i} - {y}_{j} \vert log \{ 1 + exp [ - {s}_{ij} ( {y}_{i} , {y}_{j} ) ] \} \qquad ( 3 )$$

where I(⋅) is the indicator function, the scaling |yᵢ−yⱼ| can be applied if we want to account for label differences in the loss, but should not be applied if the loss should capture only ranking. (It can also be scaled by other functions of the absolute difference.) (The loss should be added once per pair (i,j).) Plugging (2) into (3) gives a ranking loss that pushes zᵢₖ and zⱼₗ up and zᵢₗ and zⱼₖ down. Its effect on any predictions for items i and j of labels between k and l is only implicit through affecting the sums Vᵢ and Vⱼ. These middle probabilities can either go up or down, depending on the specific values. This may or may not be a desired behavior of a ranking loss. To have better control of the middle probabilities and logit values, the next subsections describe additional example loss functions.

### Example Label Value Aware Ranking Loss

This section further builds on the conditional probability view. Instead of considering the conditioning event in which yᵢ and yⱼ are permutations of (l,k), where k>l, this section considers a wider conditioning event where they can be labels in [l,k], but defines the ranking loss for the pair yᵢ=k and yⱼ=l by partitioning the range [l,k] into two events, one containing k and the other containing 1. There are multiple ways to partition the range, and each defines a different ranking loss by determining the logit sᵢⱼ. This methodology does not dictate a mutually exclusive partitioning of all possible pairwise events into disjoint sets determined by the events on which we condition, but the losses are still uniquely defined for label pairs. (They may create biases on individual labels, but they do enhance on label or relevance differences). We describe several examples using this methodology. The advantage of this approach is that it also moves logits of labels between k and l in a direction that is determined by the loss and is intuitive for multi-label rankings. It specifically creates some label smoothing over adjacent ranking labels, which may be desirable for multi-label relevance scores.

To guarantee that for yᵢ=k, yᵢ=l, k>l, zᵢₖ and zⱼₗ will go up, while zᵢₗ and zⱼₖ will go down, and all z_{iv;l<v<k}, will go up, while zⱼᵥ will go down, we define

$${s}_{ij} = log \frac{Pr ( ℓ < {y}_{i} \leq k , {y}_{j} = ℓ )}{Pr ( {y}_{i} = ℓ , ℓ < {y}_{j} \leq k )} = log [ \frac{Pr ( ℓ < {y}_{i} \leq k )}{Pr ( {y}_{i} = ℓ )} \cdot \frac{Pr ( {y}_{i} = ℓ )}{Pr ( ℓ < {y}_{j} \leq k )} ] = log [ \frac{{e}^{{Z}_{i ; ℓ + 1 : k}} / {V}_{i}}{{e}^{{z}_{i ℓ}} / {V}_{i}} \cdot \frac{{e}^{{z}_{j ℓ}} / {V}_{j}}{{e}^{{Z}_{j ; ℓ + 1 : k}} / {V}_{j}} ] = ( {Z}_{i ; ℓ + 1 : k} + {z}_{j ℓ} ) - ( {z}_{j ; ℓ} + {Z}_{j ; ℓ + 1 : k} ) \qquad ( 4 )$$

Plugging (4) in (3) gives a loss that will push up probabilities of labels l+1 up to k for item i, and down all respective label probabilities for item j, while increasing the probability of the lower label l for item j, and decreasing it for i. This is intuitively what one would expect given i has a better label than j. The logit in (4) describes

$$Pr [ {y}_{i} > ℓ , {y}_{j} = ℓ \vert ℓ \leq {y}_{i} , {y}_{j} \leq k ] = σ ( {s}_{ij} ) .$$

The conditioning event in (4) is that both labels are in [l,k]. The conditioned events are that one label is l and the other greater than l. The loss (3) is applied only for events in which one label is k and the other is l.

Alternatively to (4), we can partition the events between label k and labels l≤y<k. We can also partition the event with respect to i this way, while keeping the partition of yⱼ around l. This would push all labels v; l<v<k for both examples to lower logits. An alternative approach can combine two losses, one partitioning between {l} and {l+1, . . . , k} as in (4), and the other between {k} and {l, . . . , k−1}. This will increase the logit of k for item i, and that of l for item j, and superimpose increases and decreases for the labels between the two, where the overall net smooths the labels between l and k for both items.

In some implementations, this loss can apply additional smoothing to the intermediate labels by applying a scaling factor. One such factor can be inversely proportional to the distance between the label and l and k. For example, an inverse scaling of c/(|v−l|+1)+c/(|v−k|+1) can be applied, where c is a constant that is determined such that the sum of all scaling factors sums to 1 (or to another value). Such scaling creates a smoothing, in which greater loss is applied to labels closer to the ones observed, and the loss scales down in the range between them. Note that a similar idea can be used to smooth label losses when optimizing for individual engagement label loss, where the labels also have relevance information that may affect adjacent labels, and a goal is to focus on learning a smooth label distribution (e.g., probability mass function).

Another example approach is to partition in the middle, such that the lower half portion of labels will have loss gradients moving in the direction of l for both items i and j, and the upper half would move in the direction of label k for both items. If the range has an odd number of labels, we can either exclude the middle label (so its logit doesn't move), or include it in both events. Consider the first option, which gives

$${s}_{ij} = log \frac{Pr ( ⌈ \frac{ℓ + k}{2} ⌉ \leq {y}_{i} \leq k , ℓ \leq {y}_{j} \leq ⌊ \frac{ℓ + k}{2} ⌋ )}{Pr ( ℓ \leq {y}_{i} \leq ⌊ \frac{ℓ + k}{2} ⌋ , ⌈ \frac{ℓ + k}{2} ⌉ \leq {y}_{j} \leq k )} = ( {Z}_{i ; ⌈ \frac{ℓ + k}{2} ⌉ : k} + {Z}_{j ; ℓ : ⌊ \frac{ℓ + k}{2} ⌋} ) - ( {Z}_{i ; ℓ : ⌊ \frac{ℓ + k}{2} ⌋} + {Z}_{j ; ⌈ \frac{ℓ + k}{2} ⌉ : k} ) .$$

The logit s can be plugged into (3) to give a loss. Here, again, the loss is applied to the same conditioning event that the labels are in [l,k], but the partition of this event into the two labels is different. As the previous losses, this logit is used when yᵢ=k, yⱼ=l or vice versa, but affects labels between l and k for both items i and j. For {yᵢ,yⱼ}={k′,l′}≠{k,l}, where at least one of the labels is different, we define sᵢⱼ(k′,l′) for k′ and l′ and apply the loss with respect to the different sᵢⱼ=sᵢⱼ(k′,l′).

The methods described thus far in this section guarantee that softmax logit scores of the larger label for the item with the larger label and of the smaller label for the item with the smaller label will increase. The scores of the smaller label for the item with the large one, and of the larger label for the item with the smaller one will decrease. In the middle, scores will be controlled as designed by the specific loss. These losses will not affect logit scores of labels outside the interval [l,k], which is a desirable behavior. However, probabilities of labels outside this interval may, in fact, change because the softmax normalizers Vᵢ and Vⱼ may change. This can lead to lowering the probabilities predicted for labels v>k for the item with the larger label, or lower the probability predicted for labels v<l for the item with the smaller label. Such behavior is not desirable. However, it may be irrelevant, because this loss is focused on ranking and not on individual predictions, and ranking will only be considered through the logit scores. In applications, where the label probability is important, the ranking loss can still be combined with a direct loss that tries to best predict the label probabilities. The losses described in the remainder of this section will minimize this behavior, as they will push all logits of labels complementary to the direction of the better (or worse) label in the opposite direction.

If we only want a loss that changes ranking, but does not depend on the distances between the labels, we can partition the joint events by either the maximal label value k, or the minimal l. This will form a mutually exclusive partition of the pairwise ranking conditioning events. For label k, this gives

$${s}_{ij} = log \frac{Pr ( {y}_{i} = k , {y}_{j} < k )}{Pr ( {y}_{i} < k , {y}_{j} < k )} = ( {z}_{ik} - {z}_{jk} ) - ( {Z}_{i ; 0 : k - 1} - {Z}_{j ; 0 : k - 1} ) = ( {z}_{ik} - {Z}_{i ; 0 : k - 1} ) - ( {z}_{jk} - {Z}_{j ; 0 : k - 1} ) \qquad ( 5 )$$

This loss essentially compares the probability assigned to the k-th label to the Cumulative Distribution Function (CDF) of all labels smaller than k for both examples. Similarly, for the minimal label 1, this gives

$${s}_{ij} = log \frac{Pr ( {y}_{i} > ℓ , {y}_{j} = ℓ )}{Pr ( {y}_{i} = ℓ , {y}_{j} < ℓ )} = ( {z}_{j ℓ} - {z}_{i ℓ} ) - ( {Z}_{j ; ℓ + 1 : L - 1} - {Z}_{i ; ℓ + 1 : L - 1} ) = ( {Z}_{i ; ℓ + 1 : L - 1} - {z}_{i ℓ} ) - ( {Z}_{j ; ℓ + 1 : L - 1} - {z}_{j ℓ} ) .$$

The gradient on the loss relative to label k in (5) will push zᵢₖ up and zᵢᵥ for v<k down, and zⱼₖ down, while zⱼᵥ for v<k up. This increases the probability of the larger label for the item with the larger label, while lowering all other probabilities of the item with the larger label. Similarly, it decreases the probability of the larger label for the item with the smaller label, while increasing the probabilities of all lower labels for this item. A dual behavior, relative to the lower label, will be attained with the loss around \ell. To mix the effects for the range between the labels, we can apply both losses together.

### Example Label Difference Ranking

A different loss can consider ranking only by label differences. This calls for aggregating all pairwise events with the same label difference between the items in the pair to make this loss agnostic to the actual labels. While this yields a more complicated loss, it may be suitable when the label difference is the most important factor for ranking. Taking a conditional probability view, this loss will give a partition of the pairwise events into disjoint conditioning events on which we apply losses that can be described as negative logarithms of conditional probabilities. The partition is by the absolute difference |k−l|(or |yᵢ−yⱼ|) between the labels. The conditional probability is given by

$$Pr ( {y}_{i} > {y}_{j} \vert ‖ {y}_{i} - {y}_{j} ‖ = δ > 0 ) = σ ( {s}_{ij} )$$

and describes the conditional probability that the label of item i is greater than that of item j, conditioned on the labels being delta apart. The logit of this conditional probability that can be used in equation (3) for this loss is then given by

$${s}_{ij} = log {\sum }_{v = δ}^{L - 1} exp [ {z}_{iv} + {z}_{j , v - δ} ] - log {\sum }_{v = δ}^{L - 1} exp [ {z}_{jv} + {z}_{i , v - δ} ] .$$

It gives the log-odds ratio between the event that item i has a label which is delta larger than the label of item j and the event that item j's label is delta larger than item i's label conditioned on the event that the labels are delta apart. The loss in (3) can be weighted by delta (|yᵢ−yⱼ|) increasing the gradients in cases where the label differences are larger.

One interpretation of this approach is that the label counts engagements. With this interpretation, scaling of the loss by differences is reasonable. In other scenarios, this loss may create biases due to unequal treatment of different label pairs.

### Example Fractional Labels Pairwise Ranking

Unlike the multi-label case, we consider the case in which the model learns binary labels, but sees fractional labels. In a more general case, labels observed can be from a larger alphabet, but then, they can be mapped to [0, 1]. Assume one observes labels yᵢ and yⱼ (yᵢ>yⱼ) for an item pair (i,j). From an item population view, this can be described as if there is a yⱼ fraction of equal labels, and a yᵢ−yⱼ fraction in which the label of item i is greater than that of item j. Under the conditional notion, we can only include the latter in the ranking loss, which is conditioned on the event that the labels of i and j are unequal. Therefore, we can consider the loss as

$${L}_{ij}^{ℛ} = ( {y}_{i} - {y}_{j} ) log [ 1 + exp ( {s}_{j} - {s}_{i} ) ]$$

where sᵢ and sⱼ are the binary logits for items i and j, respectively.

### Example Extension to Poisson Regression.

The ideas proposing multi-label pairwise losses can also be applied for Poisson regression, where logit parameters are used to learn a single parameter, which is the rate of a Poisson random variable. Taking the conditioning approach, the probabilities of events that are included in each of the two conditional events between which a binary label is applied to generate the loss can be aggregated for each of the items. Similarly to the logistic regression approach, we can form sums Z_{i;l:k} taking individual probabilities defined by the Poisson distribution, and taking the logarithm over the sum. We can define zᵢᵥ as the logarithm of the probability of the event that item i takes label v. With this setup, we fit the Poisson regression to the analysis we performed for the multi-label logistic regression setting. Specifically, if we use the loss defined in equation (5), the Poisson CDF can take the place of Z_{l;0:k-1}. Thus, the single logits of an item of the Poisson regression are just mapped into multi-labels, and the same losses we defined can be used.

### Example Hierarchical Approach

An alternative partitioning method for ranking loss is to use binary logits to separate sets of labels hierarchically. Instead of using Softmax, labels will be aggregated into two sets and a binary logit distinguishes between the sets. Then, the loss evaluation system can recurse down in one of the sets to update binary logits to distinguish among all labels. This can be done for the direct engagement loss per item. Grouping can be done as a binary search tree, partitioning labels into sets of half in each level, or by separating one label from the rest in every recursion step. Ranking loss then uses the binary approach for each level. If the labels for items i and j are in the same set, no loss is incurred and recursion goes down applied on this set. Once i and j are in different partitions of the current set, a binary ranking loss is applied conditioned on the event that one label is in one partition and the other in the other. The process then stops. This approach still does not fully distinguish between labels in the same set, once the label for item i is separated from that of j. The overall logits for all labels in the set of the label yᵢ will equally move, and similarly those in the set of yⱼ, whereas the movement will happen on the binary logit score representing the set. Outside the granularity of the sets, the loss will attain an expected ranking behavior. The choice of the recursive partitioning can be made so that set logit movements are reasonable for the specific application. An additional softmax loss can be applied within a set to further identify the label after set partitioning occurred from the label of the other item.

### Example Devices and Systems

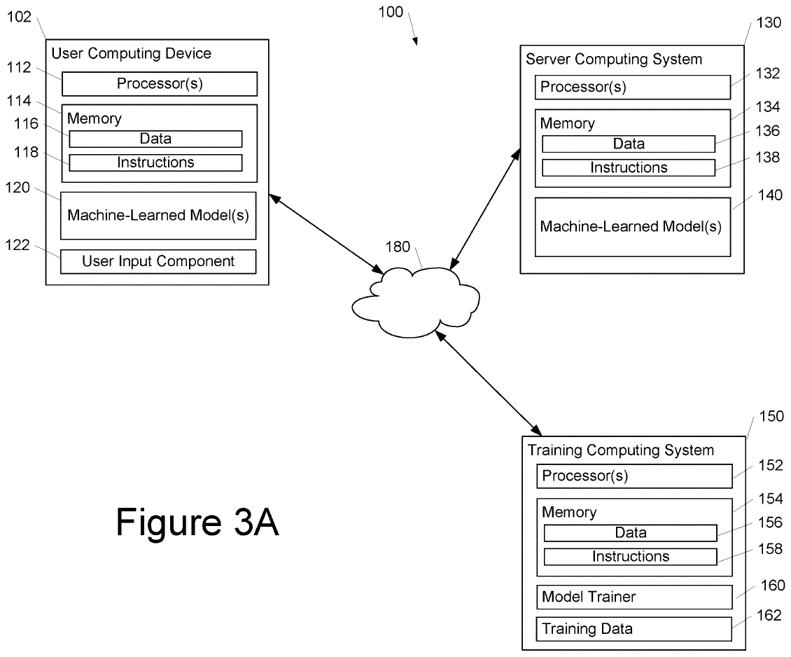

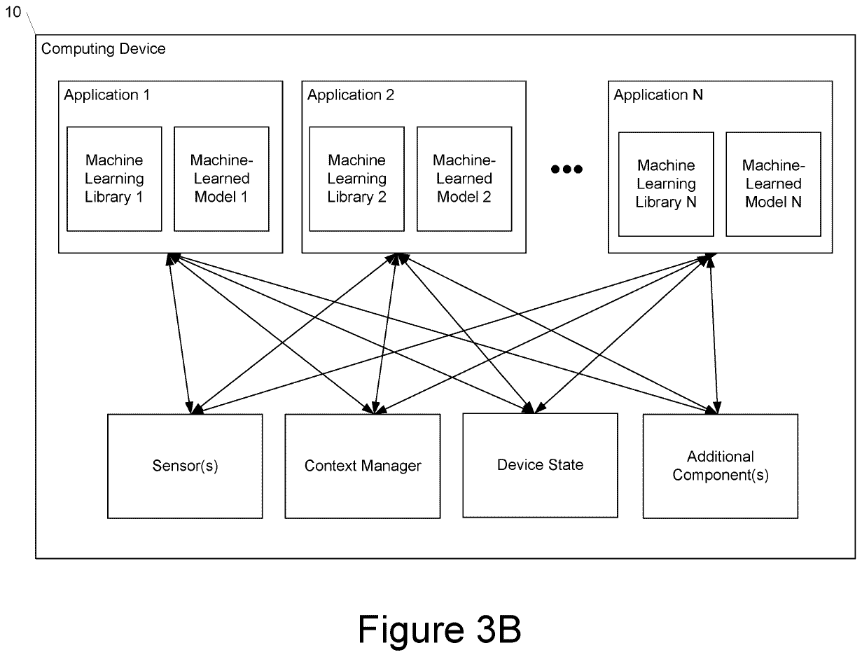

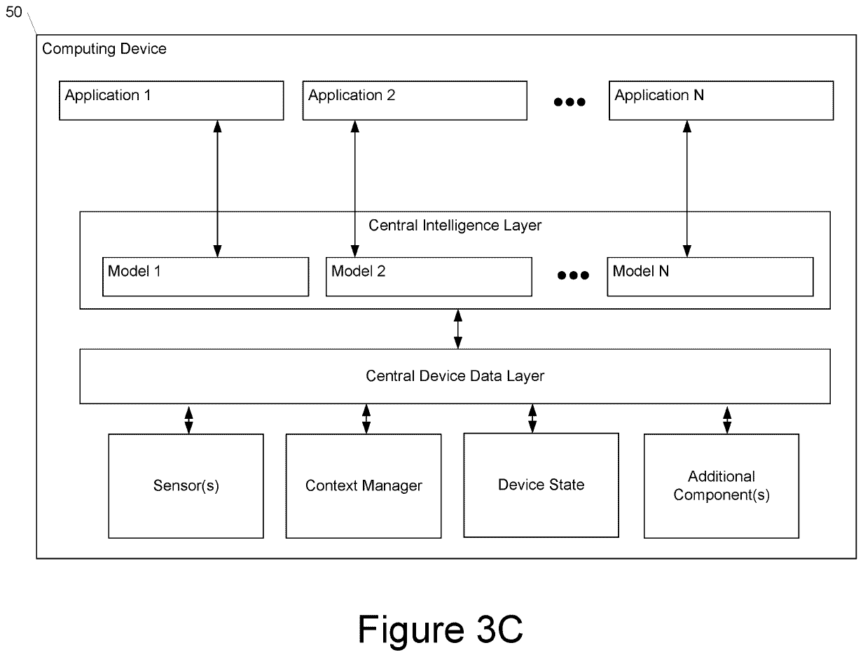

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned ranking models 120. For example, the machine-learned ranking models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned ranking models 120 can be received from the server computing system 130 over network 180, stored in the user computing device memory 114, and then used or otherwise implemented by the one or more processors 112. In some implementations, the user computing device 102 can implement multiple parallel instances of a single machine-learned ranking model 120 (e.g., to perform parallel ranking across multiple instances of pairwise inputs).

Additionally or alternatively, one or more machine-learned ranking models 140 can be included in or otherwise stored and implemented by the server computing system 130 that communicates with the user computing device 102 according to a client-server relationship. For example, the machine-learned ranking models 140 can be implemented by the server computing system 140 as a portion of a web service (e.g., a information retrieval service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned ranking models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned ranking models 120 and/or 140 based on a set of training data 162. The training data 162 can include, for example, inputs annotated with ground truth labels.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to perform training for multi-label pairwise ranking, the method comprising:
processing, by a computing system comprising one or more computing devices, a first input with a machine-learned ranking model to generate a first intermediate representation for the first input;
processing, by a computing system comprising one or more computing devices, a second input with the machine-learned ranking model to generate a second intermediate representation for the second input;
generating, by the computing system, a first label output for the first input based on the first intermediate representation, wherein the first label output is generated relative to a plurality of potential labels;
generating, by the computing system, a second label output for the second input based on the second intermediate representation, wherein the second label output is generated relative to the plurality of potential labels;
generating, by the computing system, a ranking output for the first input and the second input based on the first intermediate representation and the second intermediate representation, wherein the ranking output indicates a relative ranking between the first input and the second input; and
evaluating, by the computing system, one or more ranking loss functions based on the ranking output, wherein the one or more ranking loss functions comprise a conditional loss that is conditioned on a conditioning event partitioned into two complement sets of events; and
modifying, by the computing system, the machine-learned ranking model based on the one or more ranking loss functions.

2. The computer-implemented method of claim 1, wherein the conditioning event comprises that either:
(a) the first label output equals a first value and the second label output equals a second, different value; or
(b) the first label output does not equal the first value and the second label output does not equal the second, different value.

3. The computer-implemented method of claim 1, wherein the conditioning event comprises that both:
(a) one of the first label output or the second label output equals a first value; and
(b) the other of the first label output or the second label output equals a second, different value.

4. The computer-implemented method of claim 1, wherein the conditioning event comprises that a difference between the first label output and the second label output is at least a delta value.

5. The computer-implemented method of claim 1, wherein the conditioning event has been partitioned such that a range of the plurality of labels is partitioned into two sets of label values.

6. The computer-implemented method of claim 5, wherein the two sets of label values comprise a first set containing a first label value and a second set containing all label values that are greater than the first label value.

7. The computer-implemented method of claim 5, wherein the two sets of label values comprise a first set containing a first label value and a second set containing all label values that are less than the first label value.

8. The computer-implemented method of claim 5, wherein the two sets of label values contain equal numbers of label values, where the labels in one set are smaller than all the labels in the other.

9. The computer-implemented method of claim 1, wherein the two complement sets of events comprise a first set of events and a second set of events, and at least one of the first set of events and second set of events contains two or more events.

10. The computer-implemented method of claim 1, wherein the two complement sets of events comprise disjoint sets.

11. The computer-implemented method of claim 1, further comprising:
evaluating, by the computing system, a multi-label loss function for the first input based on the first label output;
evaluating, by the computing system, the multi-label loss function for the second input based on the second label output; and
modifying, by the computing system, the machine-learned ranking model based on the classification loss function evaluated for the first input and the classification loss function evaluated for the second input.

12. The computer-implemented method of claim 1, wherein the plurality of potential labels comprises three or more different labels.

13. The computer-implemented method of claim 1, the plurality of potential labels comprise fractional labels of a binary outcome.

14. The computer-implemented method of claim 1, wherein the first intermediate output comprises a first logit score, and wherein the second intermediate output comprises a second logit score.

15. The computer-implemented method of claim 1, wherein generating, by the computing system, the ranking output for the first input and the second input based on the first intermediate representation and the second intermediate representation comprises:
determining, by the computing system, a difference between the first intermediate representation and the second intermediate representation; and
generating, by the computing system, the ranking output for the first input and the second input based on the difference between the first intermediate representation and the second intermediate representation.

16. The computer-implemented method of claim 1, wherein:
the first label output and the second label output comprise engagement scores relative to a query; and
the ranking comprises a probability that the first input is ranked higher than the second input relative to the query.

17. The computer-implemented method of claim 1, wherein the plurality of potential labels are modeled by one or more standard probability mass functions (PMF), and wherein the one or more ranking loss functions partition the plurality of potential labels into a sum by summing the probabilities of the elements in the complement sets of events.

18. The computer-implemented method of claim 1, wherein the one or more ranking loss functions comprise a hierarchical partitioning of the plurality of potential labels, the hierarchical partitioning comprising multiple layers, each layer defining a conditioning event that partitions into two conditioned events.

19. A computer system, comprising:
one or more processors; and
one or more non-transitory computer-readable media that collectively store:
a machine-learned ranking model configured to generate ranking outputs for pairs of inputs that are responsive to a query and configured to generate a respective label output for each input relative to a plurality of potential labels, wherein the machine-learned ranking model has been trained using one or more ranking loss functions, wherein the one or more ranking loss functions comprise a conditional loss that is conditioned on a conditioning event partitioned into two complement sets of events; and
instructions that, when executed by the one or more processors, cause the computer system to run the machine-learned ranking model configured to generate one or both of: (a) ranking outputs for the pairs of inputs that are responsive to a query; or (b) the respective label output for each input relative to the plurality of potential labels.

20. The computer system of claim 19, wherein the conditioning event comprises that either:
(a) the first label output equals a first value and the second label output equals a second, different value; or
(b) the first label output does not equal the first value and the second label output does not equal the second, different value.

21. The computer system of claim 19, wherein the conditioning event comprises that both:
(a) one of the first label output or the second label output equals a first value; and
(b) the other of the first label output or the second label output equals a second, different value.

22. The computer system of claim 19, wherein the conditioning event has been partitioned such that a range of the plurality of labels is partitioned into two sets of label values.
